(19) United States
(12) Patent Application Publication
(10) Pub. No.: US 2009/0257696 A1
(43) Pub. Date: Oct. 15, 2009

(54) Bearing Element

(75) Inventor: Georg Leonardelli, Gmunden (AT)

Correspondence Address: LERNER, DAVID, LITTENBERG,;KRUMHOLZ & MENTLIK, 600 SOUTH AVENUE WEST, WESTFIELD, NJ, 07090, US

(73) Assignee: MIBA GLEITLAGER GMBH, Laakirchen (AT)

(21) Appl. No.: 12/332,636

(22) Filed: Dec. 11, 2008

(30) Foreign Application Priority Data
Dec. 11, 2007 (AT) A 2005/2007

(51) Int. Cl. F16C 35/00; C10M 133/16; C10M 111/04; C01G 39/06; C10M 103/02; C10M 103/04; C10M 103/06

(52) U.S. Cl. 384/440; 508/110; 508/555; 508/551; 508/131; 508/167; 508/166; 508/150; 508/123

(57) ABSTRACT

The invention relates to an anti-friction lacquer for producing a coating on a surface exposed to tribological stress, comprising at least one polymer which forms a polymer matrix of the coating, or at least one precursor of the polymer which forms the polymer matrix by setting, and the molecular structure of the polymer or the at least one precursor has a main chain of recurring monomer units or the precursor is this monomer unit which is part of the main chain, at least one solid lubricant, optionally at least one additive to increase solidity, as well as at least one solvent. At least the main chain of the molecular structure or the main chain part has a fully conjugated bond system.

### CROSS REFERENCE TO RELATED APPLICATIONS

Applicant claims priority under 35 U.S.C. §119 of AUSTRIAN Patent Application No. A 2005/2007 filed on Dec. 11, 2007.

### BACKGROUND OF THE INVENTION

The invention relates to an anti-friction lacquer for producing a coating on a surface exposed to tribological stress, containing at least a polymer which forms a polymer matrix of the coating or at least a precursor of the polymer which forms the polymer matrix due to polymerisation, and the molecular structure of the polymer or the at least one precursor has a main chain comprising recurring monomer units or the precursor is this monomer unit which forms a part of the main chain, at least one solid lubricant, optionally at least one additive to increase solidity, and at least one solvent, and also relates to a bearing element with a support element and a polymer layer disposed on it, containing at least one solid lubricant and optionally at least one additive to increase solidity, and the polymer has a main chain containing monomer units, and at least one other, in particular metallic, layer is optionally disposed between the support element and the anti-friction layer.

The use of anti-friction lacquers as anti-friction layers for anti-friction bearings is already amply documented in the applicant's patent specification AT 501 878 A, to which reference may be made in this connection.

Due to the ever increasing loads placed on motors, anti-friction bearings are also subjected to ever increasing stress. Efforts are therefore constantly being made to come up with new solutions for producing anti-friction bearings which are able to satisfy these requirements.

Accordingly, the objective of this invention is to propose an anti-friction lacquer and a bearing element which has improved anti-friction properties.

This objective is achieved by the invention on the basis of the anti-friction lacquer mentioned above, in which the main chain of the molecular structure of the polymer or the part of the main chain formed by the monomer units has a fully conjugated bond system and, independently thereof, is achieved by the bearing element mentioned above in which the polymer layer is formed by a polymer, the main chain of which contains a fully conjugated bond system.

During development work conducted on the anti-friction lacquer disclosed in above-mentioned patent specification AT 501 878 A, the applicant surprisingly found that anti-friction lacquers with fully conjugated bond systems in at least the main chain lead to a significant improvement with respect to anti-friction properties, in particular wear, as will be explained in more detail below, due to lower abrasion, and the adhesion strength of such anti-friction lacquers on metallic layers of bearing elements, in particular anti-friction bearings, is higher than that of anti-friction lacquers used for this purpose to date in the prior art. The reasons for this improvement in properties has not been fully explained as yet but the applicant assumes that it is attributable to the conjugated bond system and the charge distribution of the n electrons in the molecule, which is essentially more uniform across the length of the main chain. These electrons therefore have a higher degree of freedom than is the case with conventional anti-friction lacquers.

The expression main chain within the meaning of the invention is intended to mean that part of the molecular chain, i.e. alignment of atoms, which occurs due to the bonding of the monomer units. Within the context of the invention, there may naturally also be side chains on these monomer units, but in molecular structures of polymers of this type, they are of a finite length—compared with the chain length of the polymer molecule itself. In one special embodiment of the invention, these side chains may also form part of the conjugated bond system of the main chain, as a result of which they make the charge distribution within the polymer molecule even more uniform.

In one preferred embodiment, the polymer or the precursor from which the polymer is produced has an at least more or less thread-like molecular structure with an extension which preferably runs in the longitudinal direction, i.e. side chains should be present, and these should be relatively short chains compared with the main chain, for example contain a maximum of 10 carbon atoms, so that this polymer is not present in a flat cross-linked pattern, as a result of which the natural lubrication capacity of the anti-friction lacquer and hence its anti-friction properties can be further enhanced due to the reduced crystallinity of the polymer.

In particular, polymers selected from a group comprising polyamides, polyimides, polyamide-imides were found to be of particular advantage for the purpose of the invention, even though this appears to contradict the above finding with respect to the charge distribution due to the presence of heteroatoms.

The at least one solid lubricant is selected in particular from a group comprising WS₂, MoS₂, graphite, Sn, SnS and SnS₂. In particular, these solid lubricants have a positive effect on the natural lubricating capacity of the anti-friction lacquer. Within the context of the invention however, as will be explained in more detail below, it is also possible to use other solid lubricants without departing from the underlying principle of this invention.

In preferred embodiments of the anti-friction lacquer, it contains WS₂ in a proportion selected from a range with a lower limit of 17% by weight and an upper limit of 29% by weight, Sn in a proportion selected from a range with a lower limit of 2% by weight and an upper limit of 8% by weight and graphite in a proportion selected from a range with a lower limit of 12% by weight and an upper limit of 23% by weight, and the rest is formed by the polymer, or a mixture of SnS and SnS₂ in a proportion selected from a range with a lower limit of 17% by weight and an upper limit of 29% by weight, Sn in a proportion selected from a range with a lower limit of 2% by weight and an upper limit of 8% by weight and graphite in a proportion selected from a range with a lower limit of 12% by weight and an upper limit of 21% by weight, and the rest is formed by the polymer, or MoS₂ in a proportion selected from a range with a lower limit of 17% by weight and an upper limit of 29% by weight and graphite in a proportion selected from a range with a lower limit of 12% by weight and an upper limit of 21% by weight, the rest again being formed by the polymer.

WS₂ may also be used in a proportion selected from a range with a lower limit of 21% by weight and an upper limit of 27% by weight, Sn in a proportion selected from a range with a lower limit of 3% by weight and an upper limit of 6% by weight and graphite in a proportion selected from a range with a lower limit of 15% by weight and an upper limit of 18% by weight, the rest being formed by the polymer, or a mixture of SnS and SnS₂ in a proportion selected from a range with a lower limit of 22% by weight and an upper limit of 26% by weight, Sn in a proportion selected from a range with a lower limit of 3% by weight and an upper limit of 6% by weight and graphite in a proportion selected from a range with a lower limit of 15% by weight and an upper limit of 18% by weight, the rest again being formed by the polymer, or MoS₂ in a proportion selected from a range with a lower limit of 19% by weight and an upper limit of 25% by weight and graphite in a proportion selected from a range with a lower limit of 14% by weight and an upper limit of 18% by weight, the rest again being formed by the polymer.

These figures relating to composition are based on the solid content of the anti-friction lacquer.

At this stage, it should be pointed out that the figures relating to the composition of the polymer layer relate to the dry layer, i.e. without solvent, and the figures should be understood as meaning that the composition of the solid polymer layer relates to the solid content, i.e. again without solvent. Accordingly “solid content” means that proportion of the anti-friction lacquer which is left behind on the coated substrate once the solvent has been removed.

As will be explained with reference to examples below, these compositions have significantly better properties in terms of abrasion strength than is the case with anti-friction lacquers known from the prior art.

The bearing element proposed by the invention, in particular the anti-friction bearing, is provided with this anti-friction lacquer and in this respect, reference may be made to the explanations given above.

In particular, the bearing element has another layer which is a bearing metal layer made from a bronze or brass material, which forms the base for the anti-friction lacquer layer, i.e. the polymer layer.

### BRIEF DESCRIPTION OF THE DRAWINGS

To provide a clearer understanding, the invention will be explained in more detail below with reference to the appended drawings. These provide highly simplified, schematic diagrams of the following:

FIG. 1 a bearing element proposed by the invention in the form of an anti-friction bearing half-shell, viewed from an angle;

FIG. 2 a graph comparing the abrasion strength of the anti-friction lacquer proposed by the invention with anti-friction lacquers known from the prior art.

### DETAILED DESCRIPTION

Firstly, it should be pointed out that details given in the description relating to position, such as top, bottom, side, etc., refer directly to the drawing being described and, when a new position is being described, can be transposed to this new position.

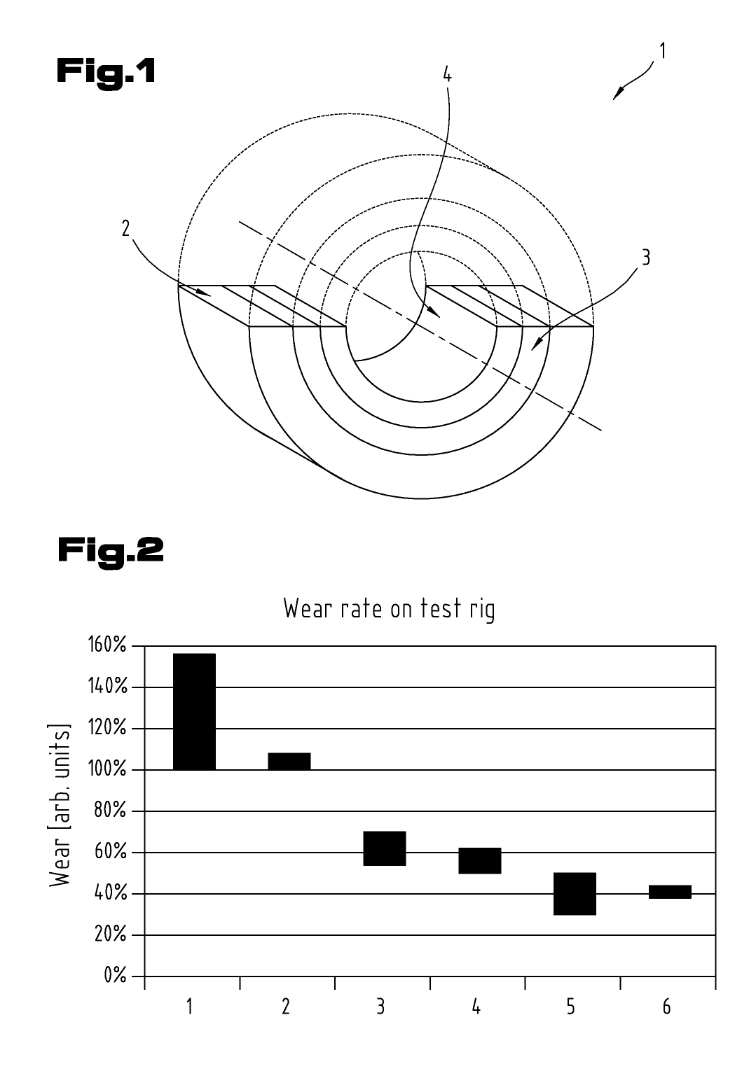

The bearing element 1 illustrated in FIG. 1 comprises a support element 2, a bearing metal layer 3 and a polymer layer 4 and is intended as a running or anti-friction layer or running-in layer. Other conventional layers may also be provided, such as binding and/or diffusion barrier layers for example, in a manner known from the prior art.

The support element 2 is usually made from steel but may naturally also be made from other comparable materials which fulfil the same or a similar function, namely imparting mechanical strength to the bearing element 1. The mechanical strength of the entire bearing element 1 will depend on the respective application, in which case it would also be possible to use a range of copper alloys, such as brass, bronze, for example. The support body 2 additionally imparts a certain amount of dimensional stability.

The bearing metal layer 3 (or running layer) is made from a bearing metal alloy. In the embodiment described as an example here, it is made from a copper alloy, in particular a bronze or brass.

In principle, it is also possible to use other bearing metal alloys known from the prior art, for example alloys based on bismuth, indium, lead, copper, aluminium. In this respect, reference may be made to AT 501 878 A.

The bearing metal layer 3 is applied by a process known from the prior art.

For the purpose of the invention, the polymer layer 4 is made from a polymer, the main chain of which has the molecular structure of a fully conjugated bond system. This polymer may be selected from a group comprising polyamides, polyimides, polyamide-imides, for example aromatic representatives of these resins, hydrogen-free polyimide resins, pyromellithic imides, such as poly-triazopyromellithic imide for example, resins containing fluorides, polystyrene, polymethylmethacrylate, poly(p)phenylene, polythiophene, polyphenylene vinylene. Copolymers may also be used, for example alternating or statistical copolymers, and it is also possible to use a mixture of these resin types.

The polyamide used may be a polyamide-amide acid, for example, with amide acid units having the formula—(NHCO)(C₆H₆)(COOH)(CONHR). These amide-amide acid units may be polymerised with amide-imide units having the formula—(NHCO)(C₆H₆)(C₂O₂NR)—in order to produce a polyamide imide. Polymerisation within the meaning of the invention should be understood as meaning both polycondensations and polyadditions. This being the case, the residue in the case of the two types of resin may be an aromatic residue in particular, for example a phenyl residue. It is also possible to use aromatic residues comprising several rings, e.g. two phenyl rings, which are linked to one another via heteroatoms, such as oxygen or nitrogen for example. These residues may in turn be substituted, i.e. have side chains. In any event, this residue within the meaning of the invention must have a conjugated bond system so as not to disrupt the conjugated bond system of the main chain of the resin because the residue is disposed in the main chain. In the case of residues which form side chains of the resin, it is not absolutely necessary for these to have these conjugated bond systems, even though this is of advantage for the purpose of the invention.

The polyamide-amide acid may be produced by reacting trimellithic acid or a derivative thereof or a trimellithic acid halogenide, e.g. an acid chloride, with at least one aromatic diamine, e.g. p-phenylene diamine. Examples of aromatic diamines are also listed in U.S. Pat. No. 3,494,890 A or U.S. Pat. No. 4,016,140 A, which are included herein by way of reference. The reaction may be conducted in N-methylpyrrolidone, for example. The molecular weight of the poly-amide-amide acid may be between 1500 and 20,000 g/mol.

The amide-imide unit may be produced by polycondensing aromatic tricarboxylic acid anhydrides, e.g. trimellithic acid anhydride, or the chlorides of these carboxylic acids, with diisocyanates or diamines. The polycondensation takes place in solution, e.g. in 1-methyl-2-pyrrolidinone.

The molar ratio of the amid-amide acid units to the amide-imide units may be within the range of between 20:1 to 4:1.

The resin may be present in at least one solvent, for example an organic solvent, such as xylene, N-methyl pyrrolidone for example, an alcohol, or water, which facilitates processability. In this respect, the proportion of solvent may be selected from a range with a lower limit of 30% by weight and an upper limit of 80% by weight, in particular with a lower limit of 40% by weight and an upper limit of 70% by weight, preferably with a lower limit of 50% by weight and an upper limit of 65% by weight, by reference to the proportion of resin, i.e. resin with solvent.

The proportion of resin in the polymer layer 4 may be selected from a range with a lower limit of 20% by weight and an upper limit of 70% by weight, in particular from a range with a lower limit of 30% by weight and an upper limit of 60% by weight, for example from a range with a lower limit of 40% by weight and an upper limit of 50% by weight.

If necessary, this polymer layer 4 may contain other additives with a view to increasing mechanical strength, such as fibre matrices and/or hard substances.

This additive or hard substance may be selected from a group comprising hard substances such as CrO₃, Fe₃O₄, PbO, ZnO, CdO, Al₂O₃, SiC, Si₃N₄, SiO₂, MnO, Si₃N₄, clay, talc, TiO₂, aluminium silicates, for example mullite, magnesium silicates, for example amosite, antophyllite, chrysotile, spheroidal carbon, carbide, for example CaC₂, MO₂C, WC, metal particles, for example Zn, Ag, Ba, Bi, bronze, Cd, Co, Cu, In, Pb, Sn, Tl, alloy particles of these metals, lead-tin alloy particles, bearing metal particles with a base of Pb or Sn, AlN, Fe₃P, metal borides, for example Fe₂B, Ni₂B, FeB, BaSO₄, metal sulphides, for example Ag₂S, CuS, FeS, FeS₂, Sb₂S₃, PbS, Bi₂S₃, CdS, chlorinated hydrogen carbonate, fluorides, for example CaF₂, metal fluorides, for example PbF₂, carbofluorides (CFₓ), metal oxide fluorides, crocidolite, tremolite, molybdenum thiocarbamates, silicides, thiophosphates, for example zinc thiophosphate.

It is also possible to use mixtures of different additives or hard substances, for example two, three, four or more different additives or hard substances.

The proportion of hard substance may be up to 15% by weight.

The fibre matrices may contain fibres selected from a group comprising inorganic fibres, for example of glass, carbon, asbestos, potassium titanate, whiskers, for example SiC, metal fibres, for example of Cu or steel, filaments with hard metal cores. These fibres also strengthen the matrix and a higher or lower matrix strength can be obtained depending on the proportion of fibres in the polymer layer 4.

The proportion of fibres may be up to 20% by weight, in particular up to 15% by weight, for example up to 12% by weight.

The solid lubricant contained in the anti-friction lacquer may be selected from a group comprising graphite, sulphides, for example MoS₂, SnS, SnS₂, WS₂, ZnS, ZnS₂, as well as hexagonal BN, PTFE, Pb, Pb—Sn alloys, CF₂, PbF₂, etc. In principle, these solid lubricants have long been used for this purpose in the prior art. Solid lubricants which have been found to be of particular advantage for the anti-friction lacquer proposed by the invention and for the polymer layer 4 on the bearing element proposed by the invention include WS₂, Sn, graphite, SnS and SnS₂, as well as MoS₂, and again, it is also possible to use mixtures of two or more solid lubricants.

The proportion of the at least one solid lubricant in the anti-friction lacquer by reference to the solid content and the polymer layer 4 may be selected from a range with a lower limit of 5% by weight and an upper limit of 60% by weight, in particular from a range with a lower limit of 10% by weight and an upper limit of 45% by weight, for example from a range with a lower limit of 12% by weight and an upper limit of 30% by weight. If more than one solid lubricant is used, the upper limit should be understood as meaning the sum of the proportions of solid lubricants.

In order to produce the anti-friction lacquer proposed by the invention, the individual components, i.e. the resin or resins with the respective solid lubricant(s) used and optionally other additives such as hard substances, are mixed with one another and introduced into a solvent, in which they are mixed. It is also possible for these ingredients of the anti-friction lacquer to be suspended or emulsified in a suspension agent or emulsifier.

The resin itself may a ready-to-use polymer but it is also possible to add only precursors to the anti-friction lacquer, in other words the relevant monomers or oligomers to be bonded to one another, which then set when the solvent is removed and thus polymerise or polycondense to produce the finished polymer, optionally at an increased temperature which may be up to 120° C.

Processing agents of a type known from the lacquer processing industry may be added to this mixture or this solution, for example anti-foaming agents, viscosity regulators, etc., but also dyes or similar, and, since this aspect has long been known, there is no need to give specific details, especially as regards the relative proportions of these processing agents in the finished lacquer. However, it should be pointed out that the relative proportions of the resin as well as the solid lubricant and optionally other additives, e.g. hard substances, are not changed as a result.

The anti-friction lacquer is preferably applied wet, for example by spraying or painting. It may be applied directly to a metal substrate, for example the bearing metal layer 3. Optionally, a so-called primer may be applied beforehand and it is also possible to create a certain degree of surface roughness prior to applying the anti-friction lacquer in order to increase the adhesive strength of the anti-friction lacquer on the bearing metal layer 3. These aspects have also long been known from the prior art.

After applying the anti-friction lacquer to the substrate, i.e. the bearing metal layer 3 of the anti-friction bearing for example, or in the case of direct coating the connecting rod, i.e. the small end thereof, a setting process takes place to produce the finished polymer layer 4 during which the solvent is evaporated. This setting process is conducted in an appropriate heat chamber. Optionally, to produce cross-linking, excitation may take place by means of UV light, laser light or electron beam, in which case appropriate initiators may be added to the anti-friction lacquer, e.g. photo-initiators.

The following test coatings were prepared using the anti-friction lacquer proposed by the invention.

### Example 1

An anti-friction bearing half-shell was produced using the method known from the prior art, comprising a steel support shell and a bearing metal layer of CuPb22Sn2. An anti-friction lacquer was then applied to this composite material, comprising a polyamide imide with 20% by weight of a mixture of SnS and SnS₂, 8% by weight Sn and 10% by weight graphite.

With respect to the mixture of SnS and SnS₂, it should be pointed out that the proportion of SnS in this mixture is between 30% by weight and 70% by weight and the rest is SnS₂.

This mixture was suspended in N-methylpyrrolidone serving as the solvent and homogenised. This anti-friction lacquer was then sprayed on and dried or thermally cured.

### Example 2

Example 1 was essentially repeated using 27% by weight WS₂, 2% by weight Sn and 23% by weight graphite as solid lubricants.

### Example 3

This example essentially corresponds to example 2 but with the proportion of graphite reduced to 15% by weight.

### Example 4

This example essentially corresponds to example 1 using 25% by weight MoS₂ and 12% by weight graphite as solid lubricants.

Abrasion tests were then conducted on examples 1 to 4. To this end, the anti-friction bearings were subjected to a test run for two hours on a test rig at a dynamic load of 98 MPa.

The results of these tests are set out in FIG. 2. It shows a comparison between the embodiments based on the invention on the one hand and a conventional anti-friction lacquer corresponding to that known from the prior art (illustrated in block 1) and an anti-friction lacquer corresponding to that disclosed in AT 501 878 A by the applicant (block 2), for which purpose coatings were also produced on anti-friction bearing elements which were then subjected to the same test conditions. Examples 1 to 4 are shown in blocks 3 to 6.

4 test runs were carried out on all the samples. Accordingly, the blocks show the minimum and maximum wear value obtained, which was measured on the basis of a loss of coating thickness. The coating thickness produced corresponded to the usual coating thicknesses applied to anti-friction bearing elements in the industry.

The values obtained were then normalised to 100% of the minimum value of the anti-friction lacquer based on the prior art (block 1).

As clearly illustrated by the diagram, the wear rate can be significantly reduced using the resin proposed by the invention based on the explanations given above.

Using the composition proposed by the invention for the polymer layer 4, it is possible to produce a running layer with good anti-friction properties and resistance to galling, which even permits dry running. This is of particular advantage due to the low maintenance. It is possible to operate with a small amount of lubricant or no lubricant. If necessary, it is possible to use water for lubrication purposes, which is of particular advantage if the bearing element 1 proposed by the invention is to be used for pumps, for example. In addition to a corresponding reduction in weight, a lower sensitivity to edge pressure can also be observed.

Instead of using the bearing element 1 proposed by the invention to make an anti-friction bearing half-shell as illustrated in FIG. 1, it may also be used in other ways, for example as a thrust ring, sliding bush, etc., in particular for use in the automotive industry. It is also possible to apply direct coatings, for example to small ends of connecting rods, in which case the support element is the connecting rod.

Not only can the anti-friction lacquer proposed by the invention be used to produce anti-friction layers on the described bearing elements 1, it can also be used in principle on surfaces which are exposed to tribological stress, for example as a running-in coating on sputtered anti-friction coatings.

For the sake of good order, finally, it should be pointed out that, in order to provide a clearer understanding of the structure of the bearing element 1, it and its constituent parts are illustrated to a certain extent out of scale and/or on an enlarged scale and/or on a reduced scale.

### LIST OF REFERENCE NUMBERS

1 Bearing element
2 Support element
3 Bearing metal layer
4 Polymer layer

1. Anti-friction lacquer for producing a coating on a surface exposed to tribological stress, comprising at least one polymer which forms a polymer matrix of the coating, or at least one precursor of the polymer which forms the polymer matrix by setting, and the molecular structure of the polymer or the at least one precursor has a main chain of recurring monomer units or the precursor is this monomer unit which forms part of the main chain, at least one solid lubricant, optionally at least one additive to increase solidity, as well as at least one solvent, wherein at least the main chain of the molecular structure or the main chain part has a fully conjugated bond system.

2. Anti-friction lacquer as claimed in claim 1, wherein the polymer or the precursor has an at least approximately thread-like molecular structure with an extension which preferably runs in the longitudinal direction.

3. Anti-friction lacquer as claimed in claim 1, wherein the polymer is selected from a group comprising polyamides, polyimides, polyamide-imides.

4. Anti-friction lacquer as claimed in claim 1, wherein the at least one solid lubricant is selected from a group comprising WS₂, MoS₂, graphite, Sn, SnS, SnS₂.

5. Anti-friction lacquer as claimed in claim 4, wherein it contains WS₂ in a proportion selected from a range with a lower limit of 17% by weight and an upper limit of 29% by weight, Sn in a proportion selected from a range with a lower limit of 2% by weight and an upper limit of 8% by weight and graphite in a proportion selected from a range with a lower limit of 12% by weight and an upper limit of 23% by weight, and the rest is formed by the polymer, respectively by reference to the solid content.

6. Anti-friction lacquer as claimed in claim 4, wherein it contains a mixture of SnS and SnS₂ in a proportion selected from a range with a lower limit of 17% by weight and an upper limit of 29% by weight, Sn in a proportion selected from a range with a lower limit of 2% by weight and an upper limit of 8% by weight and graphite in a proportion selected from a range with a lower limit of 12% by weight and an upper limit of 21% by weight, the rest being formed by the polymer, respectively by reference to the solid content.

7. Anti-friction lacquer as claimed in claim 4, wherein it contains MoS₂ in a proportion selected from a range with a lower limit of 17% by weight and an upper limit of 29% by weight and graphite in a proportion selected from a range with a lower limit of 12% by weight and an upper limit of 21% by weight, the rest being formed by the polymer, respectively by reference to the solid content.

8. Bearing element with a support element and a polymer layer disposed on it, comprising a polymer, at least one solid lubricant and optionally at least one additive to increase solidity, and the polymer has a main chain formed by monomer units, and optionally at least one other, in particular metallic, layer is disposed between the support element and the polymer layer, wherein at least the main chain of the polymer has a fully conjugated bond system.

9. Bearing element as claimed in claim 8, wherein the polymer has an at least approximately thread-like molecular structure with an extension which preferably runs in the longitudinal direction.

10. Bearing element as claimed in claim 8, wherein the polymer is selected from a group comprising polyamides, polyimides, polyamide-imides.

11. Bearing element as claimed in claim 8, wherein the at least one solid lubricant is selected from a group comprising WS₂, MoS₂, graphite, Sn, SnS, SnS₂.

12. Bearing element as claimed in claim 11, wherein it contains WS₂ in a proportion selected from a range with a lower limit of 17% by weight and an upper limit of 29% by weight, Sn in a proportion selected from a range with a lower limit of 2% by weight and an upper limit of 8% by weight and graphite in a proportion selected from a range with a lower limit of 12% by weight and an upper limit of 23% by weight, the rest being formed by the polymer, respectively by reference to the solid content.

13. Bearing element as claimed in claim 11, wherein it contains a mixture of SnS and SnS₂ in a proportion selected from a range with a lower limit of 17% by weight and an upper limit of 29% by weight, Sn in a proportion selected from a range with a lower limit of 2% by weight and an upper limit of 8% by weight and graphite in a proportion selected from a range with a lower limit of 12% by weight and an upper limit of 21% by weight, the rest being formed by the polymer, respectively by reference to the solid content.

14. Bearing element as claimed in claim 11, wherein it contains MoS₂ in a proportion selected from a range with a lower limit of 17% by weight and an upper limit of 29% by weight and graphite in a proportion selected from a range with a lower limit of 12% by weight and an upper limit of 21% by weight, the rest being formed by the polymer, respectively by reference to the solid content.

15. Bearing element as claimed in claim 8, wherein the other layer is a bearing metal layer of a bronze or brass material.
